(19) United States
(12) Patent Application Publication
(10) Pub. No.: US 2015/0133052 A1
(43) Pub. Date: May 14, 2015

(54) DEVICE SELECTION

(71) Applicant: Nokia Corporation, Espoo (FI)

(72) Inventors: Jukka Pekka Reunamaki, Tampere (FI); Arto Tapio Palin, Viiala (FI)

(73) Assignee: Nokia Corporation, Espoo (FI)

(21) Appl. No.: 14/075,154

(22) Filed: Nov. 8, 2013

(51) Int. Cl. H04W 76/02

(52) U.S. Cl. CPC H04W 76/027
USPC 455/41.2

(57) ABSTRACT

Methods and apparatus, including computer program products, are provided for device selection. In one aspect there is provided a method. The method may include receiving, at a wireless device through a short-range transceiver, a connection request received from another wireless device; rejecting, by the wireless device, the received connection request, wherein the wireless device obtains, before the rejecting, information from the received connection request to enable, based on at least the obtained information, a subsequent connection to the other wireless device; and initiating the subsequent connection to the other wireless device based on at least the information obtained from the received connection request. Related apparatus, systems, methods, and articles are also described.

### FIELD

The subject matter described herein relates to wireless communications.

### BACKGROUND

Devices, such as smartphones, user equipment, and other wireless devices configured with a short-range wireless protocol may accept one or more wireless radio connections. The wireless protocol may be implemented as a Bluetooth, a Bluetooth Low Energy, WLAN (IEEE 802.11), ZigBee (802.15.4), cellular device-to-device communications, or any other type of short-range radio access technology. The negotiation of a service level connection may, however, be time consuming and may require generating link keys, both of which may affect or burden current processes at the wireless devices.

### SUMMARY

Methods and apparatus, including computer program products, are provided for device selection.

In one aspect there is provided a method. The method may include receiving, at a wireless device through a short-range transceiver, a connection request received from another wireless device; rejecting, by the wireless device, the received connection request, wherein the wireless device obtains, before the rejecting, information from the received connection request to enable, based on at least the obtained information, a subsequent connection to the other wireless device; and initiating the subsequent connection to the other wireless device based on at least the information obtained from the received connection request.

In some variations, one or more of the features disclosed herein including the following features can optionally be included in any feasible combination. The connection request may include at least one of a host connection request, a service connection request, a profile service connection request, and an application-level service connection request. The obtained information may include an identity of the other wireless device. The identity of the other wireless device may be added to a connection list to enable the subsequent connection over a short-range link. The connection link may include a media player list. The short-range link may include at least one of a Bluetooth Low Energy link, a Bluetooth link, a ZigBee link, a cellular device-to-device link, a wireless local area link, and a Wi-Fi link. The received connection request may be received as part of a paging by the other wireless device. The other wireless device may include a media player.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF THE DRAWINGS

In the drawings,

FIG. 1 depicts an example of a system implementing device selection, in accordance with some exemplary embodiments;

FIG. 2 depicts an example of a process for device selection, in accordance with some exemplary embodiments;

FIG. 3 depicts an example of a process for paging, in accordance with some exemplary embodiments;

FIG. 4 depicts an example of a process for obtaining identity information, in accordance with some exemplary embodiments;

FIG. 5 depicts an example of a process for rejecting a host connection, in accordance with some exemplary embodiments;

FIG. 6 depicts another example of a system implementing device selection, in accordance with some exemplary embodiments;

FIG. 7 depicts another example of a process for device selection, in accordance with some exemplary embodiments;

FIG. 8 depicts another example of a process for device selection, in accordance with some exemplary embodiments;

FIG. 9 depicts another example of a process for device selection, in accordance with some exemplary embodiments; and

FIG. 10 depicts an example of an apparatus, in accordance with some exemplary embodiments.

Like labels are used to refer to same or similar items in the drawings.

### DETAILED DESCRIPTION

Service level connection negotiations between devices may be burdensome from a processing perspective at a device. As such, a device may not be ready, capable, or willing to negotiate a service level connection with another device. For example, a wireless device may be paged by another wireless device seeking to establish a short-range radio connection (including, for example, a connection between hosts), but the wireless device (which is being paged) may not be ready or otherwise willing to establish a host, profile service, or application, level connection with the other wireless device. The wireless device may, however, seek a service level connection to the other wireless device at a later time, for example, when the wireless device is ready, capable, willing, and/or needs to connect.

In some example embodiments, the subject matter disclosed herein may relate to allowing a wireless device being paged to establish a radio connection, so that the wireless device can gather one or more parameters associated with another wireless device seeking a service level connection before rejecting the service level connection. These parameters allow the wireless device to establish a subsequent service level connection. In addition to rejecting the connection before the profile service or application level connection, the connection may be rejected as well before the host level connection (which may refer to service level rejection as well). This inhibition allows the wireless device (which is otherwise not ready, capable, or willing to accept a service level connection over the short-range link) to gather and store in memory sufficient information about the other wireless device to allow a subsequent service connection at a later time to the other wireless device that requested the previously rejected service level connection (for example, via a page).

For example, the wireless device may add the other wireless device to a connection list or playlist stored in memory based on the rejected connection attempt by the other wireless device. This stored information can be used later in another connection establishment process where the other wireless device is selected based on the prior connection attempt using for example a service level protocol to obtain the information to establish the subsequent connection to the previously rejected device.

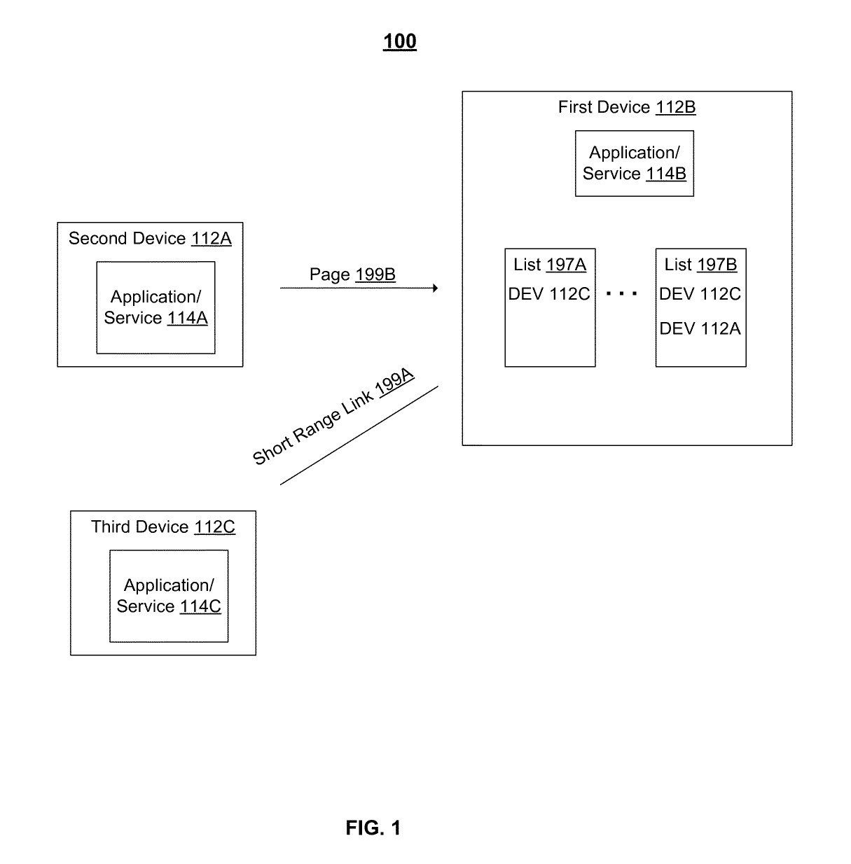

FIG. 1 depicts an example of a system 100 including a plurality of wireless devices 112A-C, each of which includes a radio transceiver for short-range communications, such as a Bluetooth link, a Bluetooth low energy link, a ZigBee link, a cellular device-to-device link, a wireless local area link, a Wi-Fi link, and the like. The wireless devices 112A-C may also include services, such as applications 114A-C. These applications may be implemented as for example a music application configured to stream music, although any other type of application maybe implemented as well. Applications 114A-C may seek service level connections in order to communicate, share media, and the like.

The first wireless device 112B may have a short-range link 199A and/or may be occupied with a task associated with another wireless device 112C. As a consequence, first wireless device 112B may not be ready or willing to establish a service level connection with second wireless device 112A, when the second device 112A initiates a service level connection by, for example, paging the first wireless device 112B. However, the first wireless device 112B may establish a radio connection to at least obtain the identity of the second wireless device 112A, add to a connection list the obtained identity information (and/or any other parameters obtained) for the second wireless device 112A, and then disconnect the radio connection or reject the service connection request from the second device 112A. In this way, the first wireless device 112B may later establish a connection based on the attempted but incomplete or rejected prior attempt by the second wireless device 112A (which may be listed on the connection list at the first wireless device 112B).

In some example embodiments, the connection list may include the identity of the device(s) to which the first wireless device can connect to over the short-range link, such as a Bluetooth link between the devices and the like. In addition to the rejected connection attempt, the decision by the first wireless device to add a device, such as the second device, to the connection list may be based on other factors as well, such as the device type, signal quality (for example, sufficient receive signal strength indicator (RSSI) and the like), connected application type, time of day, user identity, security requirements, and the like.

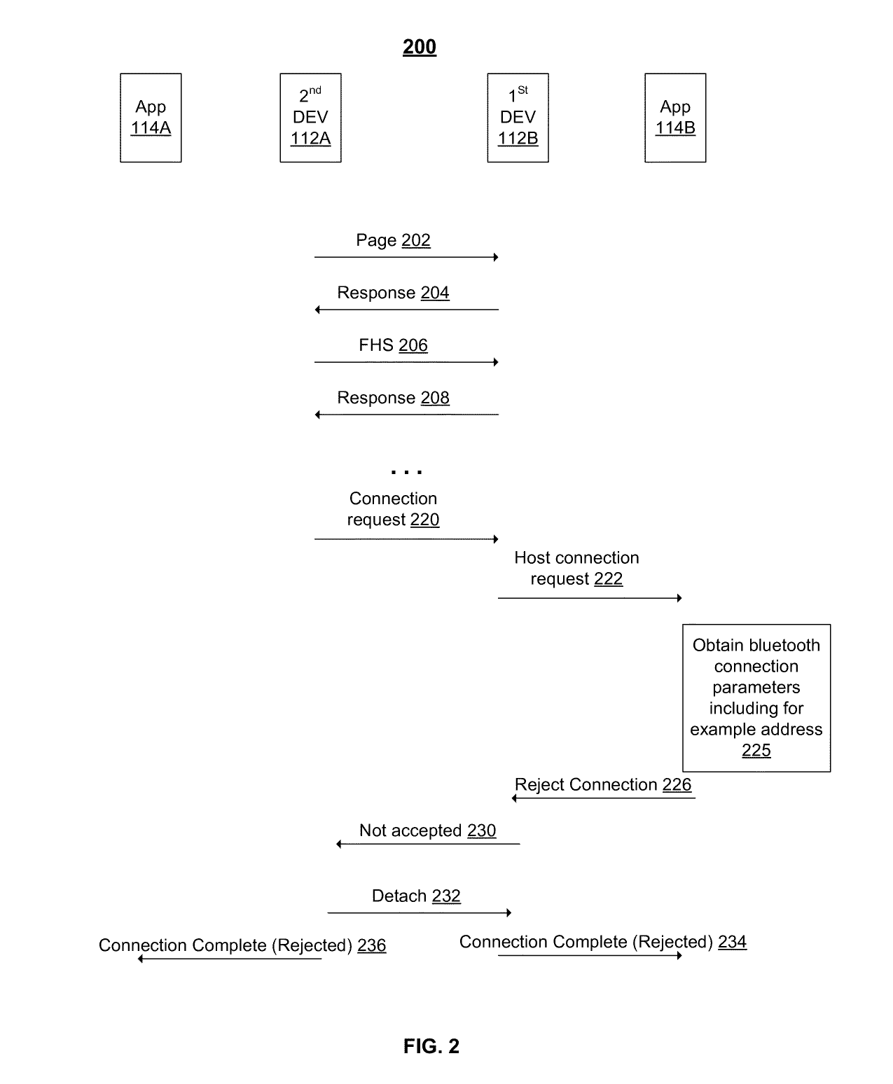

FIG. 2 depicts an example of a process 200 for selecting and adding devices to a connection list, in accordance with some example embodiments. The description of process 200 also refers to FIG. 1.

At 202, a page may be sent to initiate a short-range link between devices 112A-B, in accordance with some example embodiments. For example, the second wireless device 112A may send a page to the first wireless device 112B. In response to the page, first wireless device 112B may respond at 204 to the page with for example an identity of first wireless device 112B. At 206, second wireless device 112A may then respond by, for example, sending a frequency hopping synchronization (FHS) message to the first wireless device 112B. The FHS message may include address and/or clock information of the second device 112A. In response, the first wireless device 112B may again respond, at 208, with for example an identity of device 112B.

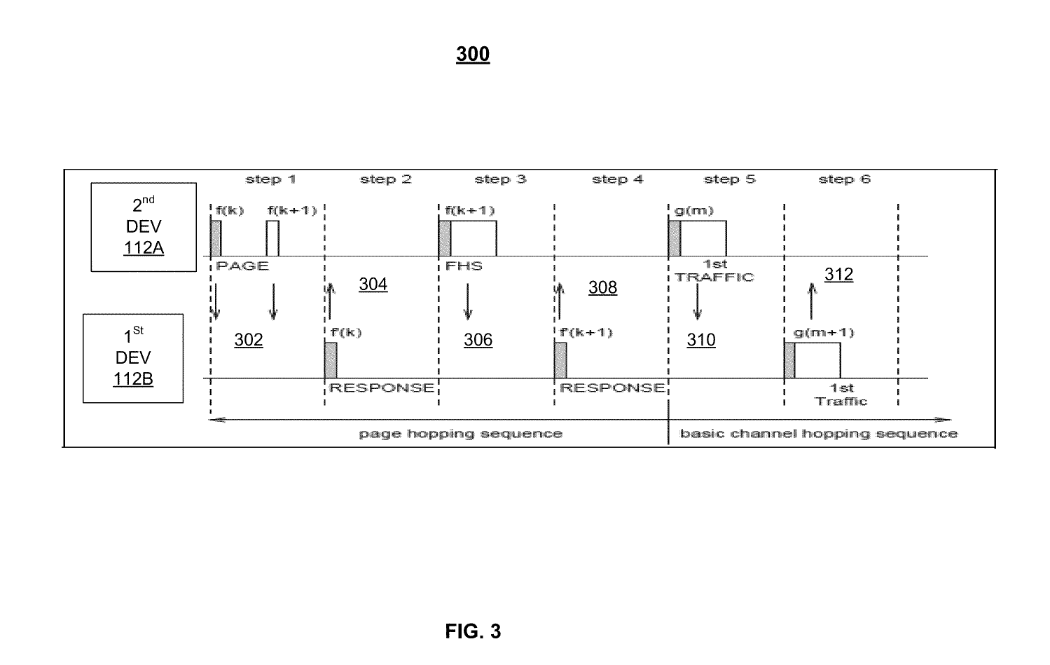

FIG. 3 depicts an example embodiment of the page response process 300 as described above with respect to 202-208, although other processes may be used as well. At 302, the second wireless device 112A may send a page, which when received by the first wireless device 112B triggers response 304. The second wireless device 112A may then send at 306 another control signal, such as an FHS message, which when received by the first wireless device 112B triggers response 308. At this point, the wireless devices 112A-B transitions from page hoping to a basic channel hopping sequence, during which some traffic can be exchanged at 310-312. This traffic may include for example a connection request as further described below, although other types of traffic may be carried as well.

In some example implementations using Bluetooth, short-range link establishment may include the use or a paging procedure depicted at FIG. 3. Moreover, when Bluetooth is used, a connection can be established with only the identity of the device but clock information obtained from the page procedure at 300 or from a previous connection with a device may accelerate the setup procedure. A device initiating connection establishment is generally considered a master of the connection, and the slave responds to the master.

Referring again to FIG. 2, the second wireless device 112A may send, at 220, a connection request to the first wireless device 112B to establish a service level connection (for example, an application or service level connection between application 114A and 114B). The first wireless device 112B may receive the connection request from a short-range link controller.

In some example embodiments, the first wireless device 112B may obtain, at 225, information about the second wireless device 112A attempting the connection. For example, first wireless device 112B may read the device identifier for the second wireless device 112A, and store the information on a connection list for later use. Although the previous example describes storing identity information for the wireless device 112A attempting to connect, other parameters may be stored as well including, for example, clock information, device type, security information, signal quality, connection time, and the like.

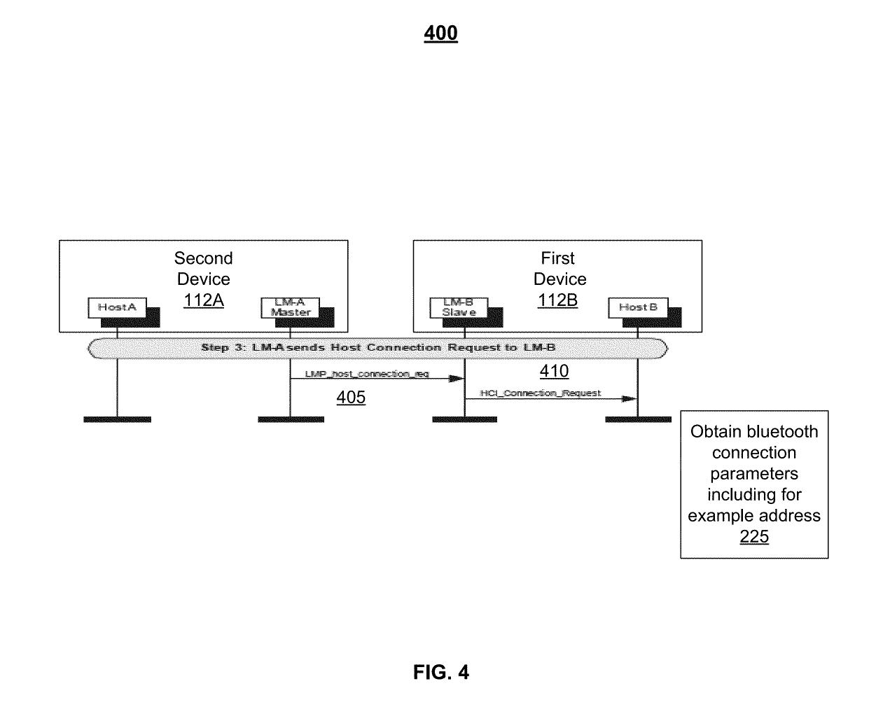

FIG. 4 depicts an example of a host connection request process 400 that can be used as noted with respect to 220-225, although other processes may be used as well.

At 405, second wireless device 112A may send a connection request, such as a link management protocol (LMP) host connection request, to first wireless device 112B. For example, a host and/or a link management at the second device 112A may send a link management protocol (LMP) message, LMP_host_connection_request, to a link manager at the first wireless device 112B. The first wireless device 112B may send an indication of this connection request to a host of first device 112B (at 410) to a host at first wireless device 112B in order to establish a host (or service) level connection between the hosts at devices 112A-B. At 225, the first wireless device 112B and/or host therein may, before rejecting the connection request, obtain information about the second wireless device 112A, such as the identity of the second device 112A attempting the connection.

Referring again to FIG. 2, at 226, a connection rejection message may be sent by the host, such as application 112B, which triggers a rejection, such as a not accepted message, to be sent at 230 to second wireless device 112A. In response to message 230, the second wireless device 112A may respond with a detach message at 232, triggering corresponding connection rejection messages at 234-236, which completes the termination of the short-range link between wireless devices 112A-B and rejection of the service (or host) level connection attempt.

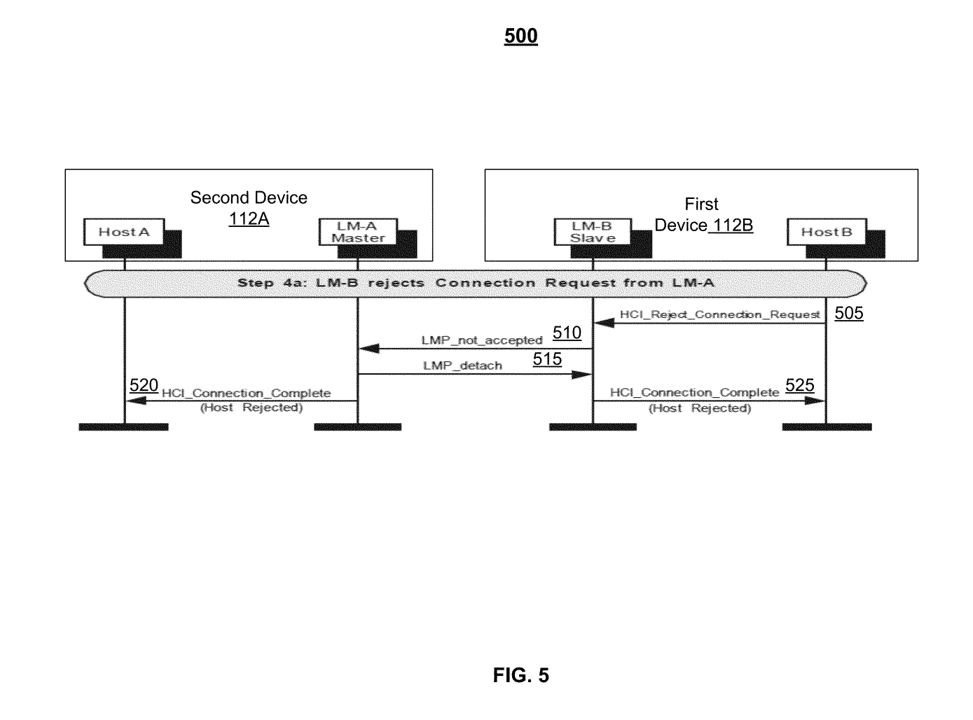

FIG. 5 depicts an example process 500 for rejecting the service (or host) level connection attempt as noted above with respect to 226-236, although other processes may be used as well.

At 505, a host at the first wireless device 112B may send an HCl reject connection request message to a link manager to reject the host level connection request by second wireless device 112A. At 510, a link manager may send a link management protocol not accepted message to a link management layer at the second wireless device 112A. At 515, a link manager at the second wireless device 112A may respond with a link management protocol detach message and corresponding HCl connection complete messages may be sent, at 520 and 525, to signal the termination of the short-range link between wireless devices 112A-B, and the rejection of the service (or host) level connection attempt.

In the case of Bluetooth, the devices may exchange LMP messages, such as LMP_features_req or LMP_features_req_ext to obtain information about devices features. The connecting device may send an LMP_host_connection_req message, which triggers an HCl_Connection_Request Event message to be sent to the connected device host. At this point, the connecting device address, class of device, and link type can be stored. The connection can then be rejected as shown in FIG. 5. There may be additional information obtained, such as accepting a connection and reading RSSI value, without making a service level connection and then disconnecting the link.

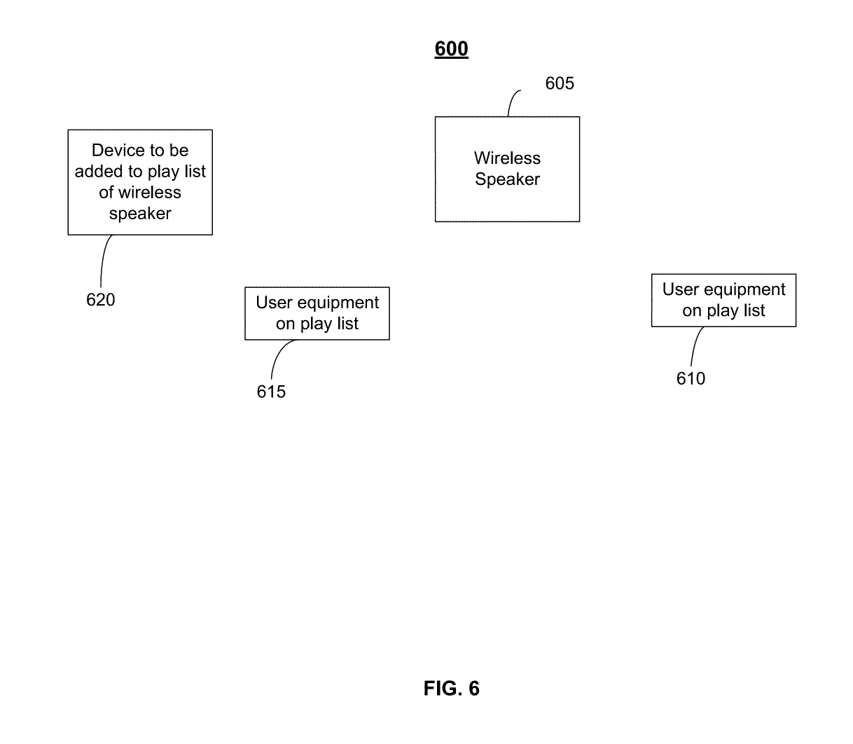

FIG. 6 depicts an example of a system 600, in accordance with some example embodiments. The system 600 includes a wireless device 605, such as a wireless speaker system having a short-range radio protocol transceiver coupled to wireless device 610, which is streaming a song to wireless device 605. Wireless devices 610 and 615 may be listed on a list (for example, Bluetooth connection list, play list, and the like) at wireless device 605, so wireless device 605 may couple to wireless devices 610 and 615 (for example, to stream songs from the wireless devices 610 and 615). While wireless device 605 is coupled and streaming a song from a wireless device, such as device 610, the wireless device 605 may receive a page from wireless device 620 seeking a service level connection with wireless device 605. However, wireless device 605 may establish a radio connection, such as a short-range radio link, with wireless device 620 and proceed as noted above with respect to process 200 to record the identity and other information about wireless device 620 before terminating the radio connection and rejecting the service level connection as noted above. With the identity of wireless device 620, wireless device 605 may later couple to wireless device 620 despite the fact that the previous connection attempt was rejected. For example, after wireless device 605 streams songs from devices 610 and 615, wireless device 605 may want/need to stream a song from wireless device 620, and thus wireless device 605 may create the service level connection by coupling to wireless device 620 based on the information obtained from the previous attempt.

To illustrate further with an example, wireless device 605 may be implemented as a Bluetooth wireless speaker having a playlist functionality that allows the Bluetooth wireless speaker 605 to play songs from one or more other wireless devices in some sort of sequence. In this example, Bluetooth wireless speaker 605 may be playing a song from one of the devices, such as device 610 or device 615. While playing the song, one of the other devices 620, such as a smart phone or other user equipment, may attempt to connect to the Bluetooth wireless speaker 605 to establish a service level connection, so that the Bluetooth wireless speaker can play songs resident on the device 620 attempting the connection. Bluetooth wireless speaker 605 may not be willing to establish a service level connection from device 620 as processing a service level connection (for example, an application level connection) may interfere with the playing of the song. As such, Bluetooth wireless speaker 605 may instead establish a lower-layer radio connection, store one or more parameters associated with the connecting wireless device 620, and then reject the service level connection request. In this way, the Bluetooth wireless speaker 605 may store the identity and the like of the wireless device 620 attempting the connection, and add the attempting device 620 to a connection list of devices to which the Bluetooth wireless speaker 605 can connect. As such, the Bluetooth wireless speaker 605 may, at a later time, establish a service connection to the previously rejected wireless device 620 in order to provide the service (for example, stream a song from device 620).

By storing for example a Bluetooth address without any service level connection, the wireless Bluetooth speaker 605 may serve as a shared speaker (for example, playing songs and the like) for devices 610, 615, 620, and the like. The devices 610-620 may play/stream a song but not have a specific protocol defined to add a device into the device playlist at 605, or devices 610, 615, and 620 may not be paired with device 605. The pairing while streaming music from another device may cause interference to audio and may not be always active (adding a new device may cause a request for an owner device to accept a new pairing, if one exists). When device 610 or 615 take their turn playing music on wireless speaker device 605, the pairing may be initialized and the playing can be started from the speaker side. The shared speaker is only an example and as other delayed pairing applications may be implemented as well (for example, delaying the pairing to ask user permission, gaming application having random connection times, or applications/service having only one active connection at a given time).

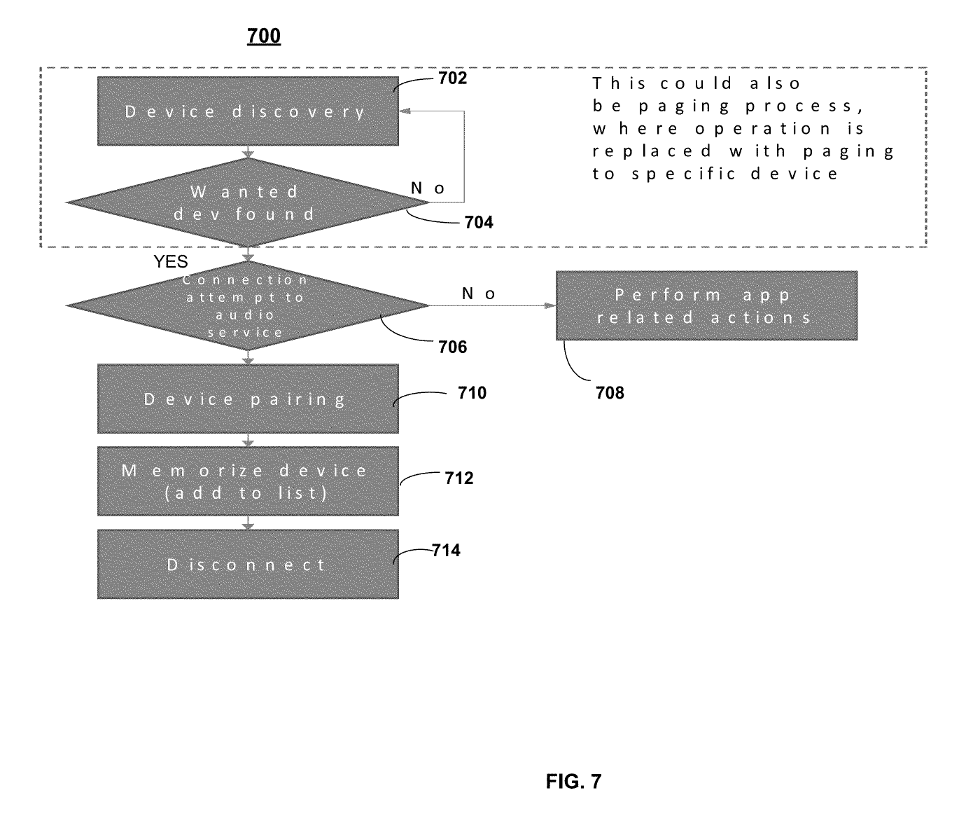

FIG. 7 depicts an example of a process 700 for obtaining device information for a device attempting a connection but rejected, in accordance with some example embodiments. The description of process 700 also refers to FIG. 1.

At 702, a wireless device, such as second wireless device 112A, may perform device discovery by at least sending a page to one or more wireless devices, such as wireless device 112B. The page may be directed to a specific device, or device 112A may use an inquiry to discover plurality of devices. For example, a page compatible with Bluetooth, Bluetooth Low Energy, or any other short-range radio technology may be transmitted (or received) by a wireless device. At 704, the second wireless device 112A may find first wireless device 112B based on a response message as noted above at 204 and the like. If a connection is desired or requested to an application, such as an audio application stream, a device pairing procedure in accordance with Bluetooth, Bluetooth Low Energy, and the like may be initiated (yes at 706 and 710). If not (no at 706), first wireless device 112A may perform other operations at 708, such as sending object to another device, such as picture.

At 710, the device pairing may proceed but rather than allow a service level connection to a host at the second wireless link to proceed, the second wireless device 112A may, at 712, store identification information for the first wireless device attempting the pairing. When the identity information is obtained and stored (for example, by adding second wireless device 112A to the connection list at first wireless device 112B), the second wireless device 112A may reject the service request and terminate (or disconnect) the radio connection to the first wireless device 112B attempting the connection.

In the example of FIG. 7, the second wireless device 112A may be implemented as the wireless speaker device 605 to which device 620 seeks or needs to be added to the connection list of device 605. Device 620 is thus attempting to use an audio sink of device 605, and the audio service requires for example a Bluetooth or Bluetooth Low Energy pairing. However, after the pairing for the audio service connection is denied and the device address of device 620 is added to the playing device list at 605, the service connection is rejected (and any radio connection(s) disconnected). If the service level access is other than audio, then the process is handled as required by the other service.

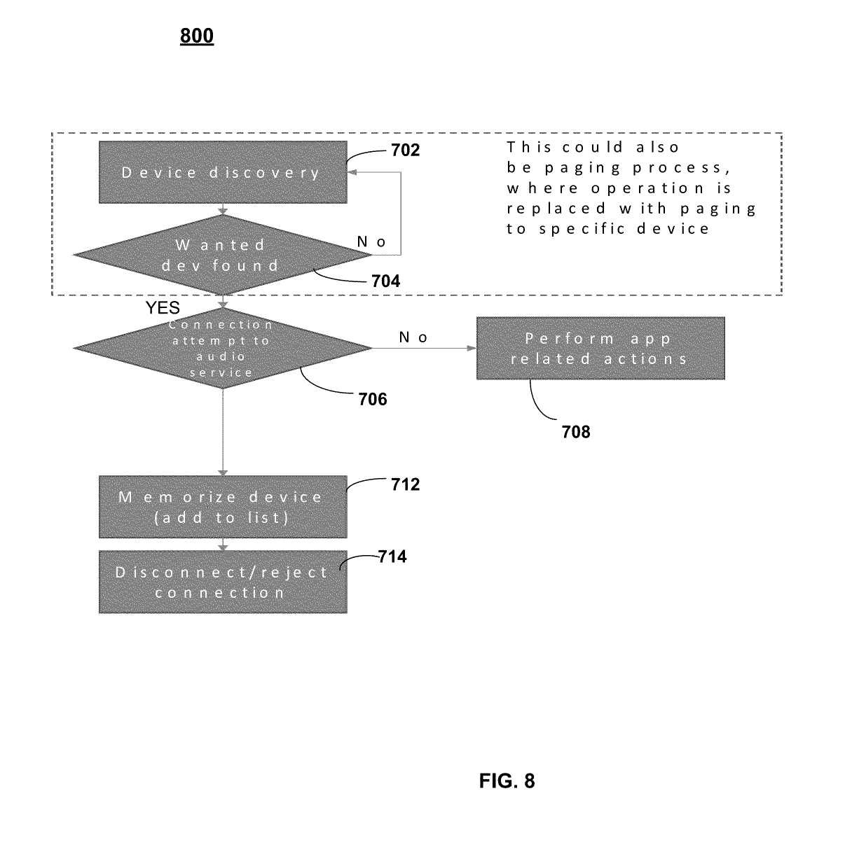

FIG. 8 depicts another example of a process 800 obtaining device information for a device attempting a connection but rejected, in accordance with some example embodiments. The description of process 800 also refers to FIG. 1. Process 800 is similar to process 700 in some respects but the pairing is not performed at 710 (for example, when the devices have been previously paired).

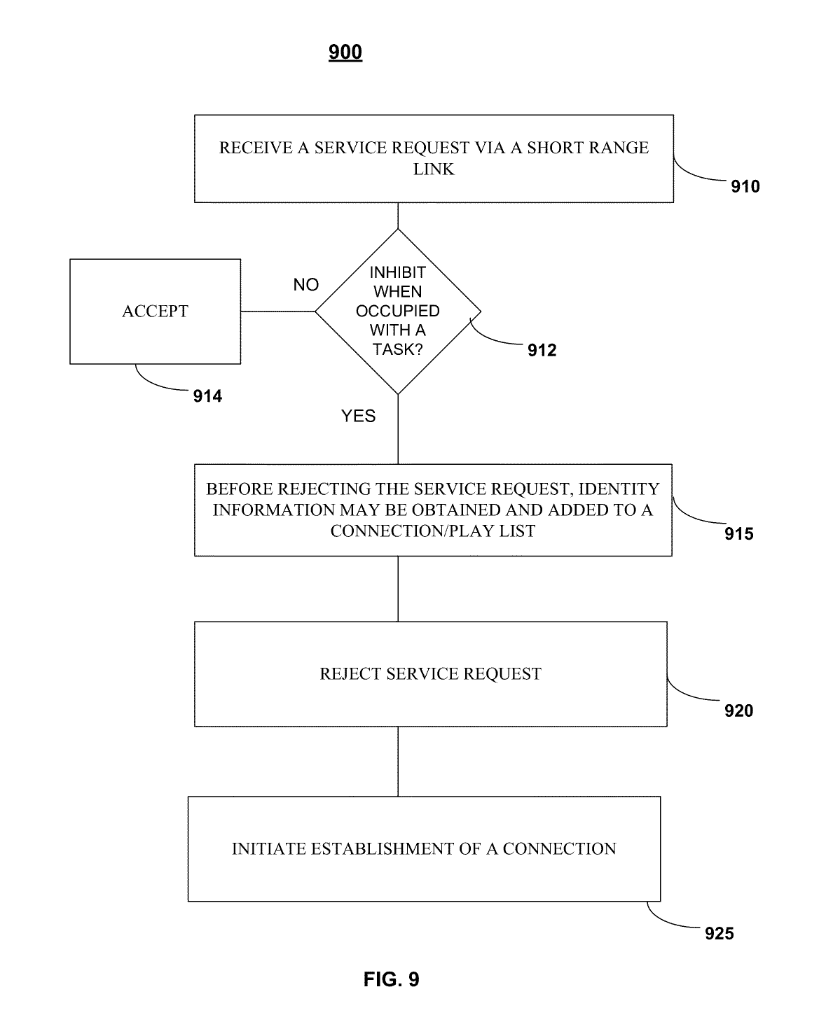

FIG. 9 depicts a process 900 for device selection, in accordance with some example embodiments. The description of FIG. 9 also refers to FIGS. 1 and 2.

At 910, a service request for a short-range radio protocol connection may be received from a device attempting a service level connection via the short-range radio protocol connection, in accordance with some example embodiments. For example, second device 112A including application 114A may send to first device 112B a service level connection request, an example of which is described above with respect to 220 at FIG. 2. However, first device 112B may not be ready, willing, capable, or in need of the service level connection, in which case first device 112B may inhibit processing of the service request at 912. For example, first device 112B may want to delay establishment of the service level connection because first device 112B may not be able to handle the processing of the service/host level request due to processing of another task, such as streaming media, such as music and the like. When this is the case, first device 112B may thus reject the service request by canceling the service request (and/or a host-level connection request). In this example, the service (or host) request represents an application-to-application request (for example, to stream music and the like). However, if the device is not otherwise occupied with a task or otherwise ready to process a service request, first device 112B may accept, at 914, the request received at 910.

At 915, before rejecting the service request, identity information may be obtained for the device attempting a service level connection via the short-range transceiver connection, in accordance with some example embodiments. For example, first device 112B including application 114B may obtain and store the identity of device 112A. The device identity information may include the address, such as Bluetooth address, of second device 112A, although other identity information may be used as well as noted above with respect to 225 at FIG. 2. This device identity information may be added to a connection list, which can be accessed by first device 112B to make a subsequent service level connection to second device 112A.

At 920, the service request may be rejected, in accordance with some example embodiments. After obtaining and storing the identity information, first device 112B may send a connection rejection message to reject the host connection request received at 220. An example of connection rejection is described with respect to 226 and 230.

At 925, a service connection may be subsequently established, in accordance with some example embodiments. For example, first device 112B may at a later time access the identity information for device 112A in order to establish (for example, initiate or accept) a service connection with previously rejected second device 112A.

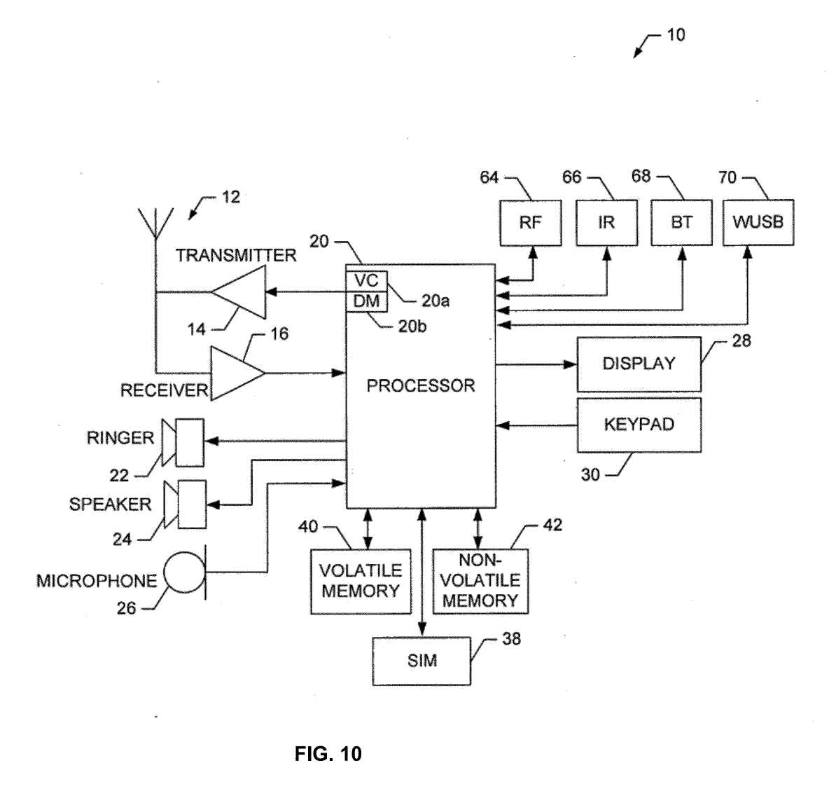

FIG. 10 illustrates a block diagram of an apparatus 10, which can be configured as a wireless device, in accordance with some example embodiments. For example, apparatus 10 may be implemented at wireless devices 112A-C and 605-620. Apparatus 10 may be implemented as a smart phone, mobile station, a mobile unit, a subscriber station, a wireless terminal, a tablet, a wireless plug-in accessory, or any other device with a short-range transceiver, such as Bluetooth, Bluetooth Low Energy, and the like. In some example embodiments, one or more portions of the apparatus 10 may be incorporated into a media player, such as a television, wireless speaker, and the like.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 10 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 10, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth (BT) transceiver 68 operating using Bluetooth wireless technology, a wireless universal serial bus (USB) transceiver 70, a Bluetooth Low Energy link, ZigBee link, a cellular device-to-device link, a wireless local area link, a Wi-Fi link, and/or any other short-range radio technology. In this regard, the apparatus 10 and, in particular, the short-range transceiver may be capable of transmitting data to and/or receiving data from electronic devices within the proximity of the apparatus, such as within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as an international mobile equipment identification (IMEI) code, capable of uniquely identifying apparatus 10. The functions may include one or more of the operations disclosed herein with respect to the user equipment and devices, such as the functions disclosed at processes 200-500, 700, 800 and the like. The memories may comprise an identifier, such as an international mobile equipment identification (IMEI) code, capable of uniquely identifying apparatus 10. In the example embodiment, the processor 20 may be configured using computer code stored at memory 40 and/or 42 to enable making host (and/or service) connections, rejecting host connections, obtaining and storing identity information, and/or the like as disclosed herein.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 10. A computer-readable medium may comprise a non-transitory computer-readable storage medium that may be any media that can contain or store the instructions for use by or in connection with an instruction execution system, apparatus, or device, such as a computer. In addition, some of the embodiments disclosed herein include computer programs configured to cause methods as disclosed herein.

Without in any way limiting the scope, interpretation, or application of the claims appearing below, a technical effect of one or more of the example embodiments disclosed herein is that a device can delay pairing and service connections.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

1. A method comprising:
receiving, at a wireless device through a short-range transceiver, a connection request received from another wireless device;
rejecting, by the wireless device, the received connection request, wherein the wireless device obtains, before the rejecting, information from the received connection request to enable, based on at least the obtained information, a subsequent connection to the other wireless device; and
initiating the subsequent connection to the other wireless device based on at least the information obtained from the received connection request.

2. The method of claim 1, wherein the connection request comprises at least one of a host connection request, a service connection request, a profile service connection request, and an application-level service connection request.

3. The method of claim 1, wherein the obtained information includes an identity of the other wireless device.

4. The method of claim 3 further comprising:
adding the identity of the other wireless device to a connection list to enable the subsequent connection over a short-range link, the connection list comprising a media player list.

5. The method of claim 4, wherein the short-range link comprises at least one of a Bluetooth Low Energy link, a Bluetooth link, a ZigBee link, a cellular device-to-device link, a wireless local area link, and a Wi-Fi link.

6. The method of claim 1, wherein the received connection request is received as part of a paging by the other wireless device.

7. The method of claim 6, wherein the other wireless device comprises a media player.

8. An apparatus comprising:
at least one processor circuitry; and
at least one memory circuitry including computer program code, the at least one memory circuitry and the computer program code configured to, with the at least one processor circuitry, cause the apparatus to perform at least the following:
receive, by the apparatus through a short-range transceiver, a connection request received from a wireless device;
reject, by the apparatus, the received connection request, wherein the apparatus obtains, before the reject, information from the received connection request to enable, based on at least the obtained information, a subsequent connection to the wireless device; and
initiate, by the apparatus, the subsequent connection to the wireless device based on at least the information obtained from the received connection request.

9. The apparatus of claim 8, wherein the connection request comprises at least one of a host connection request, a service connection request, a profile service connection request, and an application-level service connection request.

10. The apparatus of claim 8, wherein the obtained information includes an identity of the wireless device.

11. The apparatus of claim 10, wherein the apparatus is further configured to at least add the identity of the wireless device to a connection list to enable the subsequent connection over a short-range link, the connection list comprising a media player list.

12. The apparatus of claim 11, wherein the short-range link comprises at least one of a Bluetooth Low Energy link, a Bluetooth link, a ZigBee link, a cellular device-to-device link, a wireless local area link, and a Wi-Fi link.

13. The apparatus of claim 8, wherein the received connection request is received as part of a paging by the wireless device.

14. The apparatus of claim 13, wherein the wireless device comprises a media player.

15. An apparatus comprising:
means for receiving a connection request received from a wireless device;
means for rejecting the received connection request, wherein the apparatus obtains, before the rejecting, information from the received connection request to enable, based on at least the obtained information, a subsequent connection to the wireless device; and
means for initiating the subsequent connection to the wireless device based on at least the information obtained from the received connection request.

16. A non-transitory computer-readable storage medium including computer program code, which when executed by at least one processor circuitry causes operations comprising:
receiving a connection request received from a wireless device; and
rejecting the received connection request, wherein information is obtained, before the rejecting, from the received connection request to enable a subsequent connection to the wireless device; and
initiating the subsequent connection to the wireless device based on at least the information obtained from the received connection request.

17. The non-transitory computer-readable storage medium including computer program code of claim 16, wherein the obtained information includes an identity of the wireless device.

18. The non-transitory computer-readable storage medium including computer program code of claim 16, which when executed by at least one processor circuitry causes further operation comprising adding the identity of the wireless device to a connection list to enable the subsequent connection over a short-range link, the connection list comprising a media player list
